(19) United States
(12) Patent Application Publication
(10) Pub. No.: US 2015/0095161 A1
(43) Pub. Date: Apr. 2, 2015

(54) Universal Retail App and Auxiliary Methods

(71) Applicant: Anurag Goel, Pleasanto, CA (US)

(72) Inventor: Anurag Goel, Pleasanto, CA (US)

(21) Appl. No.: 14/043,854

(22) Filed: Oct. 2, 2013

(51) Int. Cl. G06Q 30/02

(52) U.S. Cl. CPC G06Q 30/0267
USPC 705/14.64

(57) ABSTRACT

Schemes and methods are described whereby a single Universal Retail App for mobile communications and computing platforms auto-detects its fine-grained location within or outside retail locations and launches itself with a retailer or collection of retailers' native branding and retailer specifiable messaging. Methods are described for use of ISM Band devices as locationing beacons where GPS may not be available. Also described is MBox, a self-managing, real-time, always in-context by-location promotional messaging system that stays out of consumers' personal messaging channels and that can be used by retailers in conjunction with the Universal Retail App. A Universal Shopping Cart usable across all retail establishments and embeddable in the Universal Retail App that allows secure conduct of eCommerce is also disclosed.

### CROSS-REFERENCE TO RELATED APPLICATIONS

Priority dates for this patent have been established by prior U.S. Provisional Patent Application Ser. No. 61/708,303, entitled “Universal Retail App for Mobile Communications and Computing Platforms” filed on Oct. 1, 2012 by Anurag Goel; Ser. No. 61/727,625, entitled “Universal Shopping Cart for Mobile and Desktop Computing and Communications Platforms” filed on Nov. 16, 2012 by Anurag Goel; and Ser. No. 61/734,888, entitled “MBox—A Non-Intrusive Mechanism for Retailers to Send Real Time, One to One, Personalized, Location and Context Relevant Messages to Consumers” filed on Dec. 7, 2012 by Anurag Goel.

### STATEMENT REGARDING FEDERALLY SPONSORED RESEARCH OR DEVELOPMENT

Not applicable.

### REFERENCE TO A SEQUENCE LISTING, A TABLE, OR A COMPUTER PROGRAM, LISTING COMPACT DISC APPENDIX

Not applicable.

### BACKGROUND OF THE INVENTION

The present invention relates to technologies for real-time two way communication between Retailers and Shoppers to facilitate the conduct of retail and more particularly relates to systems and methods for retailers to determine fine-grained location of their mobile phone bearing customers in stores, send them personalized messaging and facilitate the customers' purchasing activities in-store as well as online.

Retail Businesses constantly have a need to advertise themselves to potential and existing customers and send them enticements in terms of sales announcements, specials deals and offers. Regular advertising channels such as TV advertising, print advertising and Internet advertising mostly do not reach customers in real-time while they are at or near the Point-of-Purchase (POP) and when they are likely to make imminent purchases. Messages sent via emails to target customers are mostly viewed and ignored by people as spam and considered a great annoyance since the spam emails get mixed up with personal and business email and have to be sorted through and deleted several times daily. Messages sent via “Text Messaging” are considered an even greater annoyance. The current methods of Retailer to Consumer communications are neither efficient nor do they serve the needs of either party well.

Smartphones or tablets built on mobile communications and computing platforms, with “over-the-air” Internet access and the ability to run applications, commonly known as “apps”, are what the Retailers are beginning to favor for personalized messaging to their customers. This patent application will hereafter refer to Smartphones with the intent of being inclusive of mobile phones, tablets or any other device built on a mobile communications and computing platform. Because of the ubiquity of Smartphones, every retailer big or small wants to put out free apps for their customers to download from the apps' marketplaces and use their branded apps to send marketing messages to their customers. While this establishes the need for one-to-one personalized marketing, downloading and using a separate app for every retailer does not work for the shoppers. Even if shoppers download and install hundreds to thousands of retailer-specific app on their Smartphones, there is a big barrier of inconvenience that prevents them from searching the right app to launch when they enter a particular branded store. Even when the shoppers are offsite, it becomes quite inconvenient to scroll through all the Smartphone-installed apps and launch the desired one.

Retailers have the need to send not only personalized messaging to shoppers but also make the messaging real-time and context specific to the location that the shoppers may be at, or risk alienating the shoppers. Mobile Phones and Smartphones today commonly have GPS capabilities built into them allowing those devices to locate and use their coordinates such as in terms of the standard latitude/longitude pair. GPS functionality may not work in indoor locations or may not differentiate multi-storey locations at the same latitude/longitude, and location needs to be discovered using alternate means. Certain applications may also call for location determination using means other than GPS locationing regardless of whether Smartphone is indoors or outdoors.

Once a Retailer has the means to locate a shopper at a specific location within his store and has appropriately messaged the shopper, the shopper has to make a purchase-now or not decision for the merchandize in front of him. If the shopper is inclined to make the purchase but wants to defer the decision, it may result in a lost sale to the Retailer. Thus the Retailer needs a means for the Shopper to remember the merchandize and even a convenient way to be able to buy it later even if the Shopper has left the store. A virtual shopping cart on the shopper's Smartphone that works across different Retailers would be such a device but does not currently exist. Shopping Cart applications currently exist that Retailers can imbed in their Web pages to allow their customers to conduct purchasing on their websites. These Web pages can be for desktop or mobile browsers. Similarly, retailers can have their own branded apps on a mobile device which can allow their customers to make in-app purchases. The drawback of both of these schemes is that the Shopping Cart application is imbedded either in a branded site or in a branded mobile app and requires a separate sign-in for each retailer for authentication and purchase. Additionally, each Retailer has a relationship with certain Payment Processors that they use to accept payments for purchases made through their shopping carts. No shopping cart app currently exists that can be imbedded in any website or within a mobile app, and while physically browsing at any Retailer's brick-and-mortar or online store, can be used to drop items into the shopping cart, and later on be able to browse, edit and buy from multiple Retailers without requiring a sign-on for every retailer.

### BRIEF SUMMARY OF THE INVENTION

This invention describes schemes and methods whereby a single Universal Retail App (URA) for mobile communications and computing platforms auto-detects its location and launches itself with that store's native branding, store information, services, product offerings and other messaging. In addition, the Universal Retail App presents its messaging and services on the mobile communications and computing platform based on fine-grained retailer-specifiable location within the store. The Universal Retail App also allows secure conduct of eCommerce as part of the store services on the mobile platform on which it resides.

If all of the information is downloaded and presented all at once to the shoppers on their Smartphones, it can lead to an information overload and may cause the shoppers to ignore the messaging or turn the app off entirely. The URA meters out information to the shoppers in a context and location sensitive fashion at the point-of-purchase, personalizing it via various means such as shopping history, shopper set filters etc. This invention also describes schemes and methods that the URA relies on whereby Smartphone devices can extract location information meaningful in context of the applications running on the Smartphone devices, from ISM Band transceivers in their normal operating modes or configured as range configurable beacons and without requiring any changes to the Smartphone devices' configurations or hardware.

While having a single app, the URA, that works across all Retailers seamlessly, solves the problem of proliferation of apps, their management and their efficient use, it also creates a need for the shopper to conduct eCommerce with any store from within the URA during the shoppers' interaction with the app within or outside stores. The URA also implements a Universal Shopping Cart (USC) feature that allows shoppers to add merchandize to this virtual shopping cart in the URA to conduct eCommerce seamlessly with any retailer in a payment processor agnostic fashion.

The URA also prescribes a cost-effective method for any Retailer to send promotional messaging to likely customers, without the use of the customers' private email, phone, text or snail-mail channels, and have the messaging delivered in real-time while the customers are at, or near the Retailer's physical sales outlets.

### BRIEF DESCRIPTION OF THE SEVERAL VIEWS OF THE DRAWINGS

FIG. 1: Location Based Messaging-Type Decision by the Universal Retail App

FIG. 2: Shopper not “near” a mall use case

FIG. 3: Shopper “near” a mall use case

FIG. 4: Shopper's Entry into Store use case

FIG. 5: Shopper Enters a Defined Area in a Store use case

FIG. 6: Universal Retail App's 3 modes of operation

FIG. 7: Message Personalization by the Universal Retail App

FIG. 8: Mapping of UserID to Anonymized_UserID is done on the URA_Server

FIG. 9: Mapping of UserID to an email handle MBoxID_N on a domain name pointing to URA_Server

FIG. 10: Retailers' push of Timed and Personalized Offers (TPOffers) and/or Personalized and Location specific URLs (TPLocationURLs) to Customer MBox on URA_Server

FIG. 11: Universal Retail App (URA) Host Device pulls Location based and Personalized MBox content and URLs from URA Server

FIG. 12: This figure shows an example of ISM Beacons' implementation for a typical grocery store showing how their coverage areas may be adjusted by adjusting their signal strengths. Coverage may overlap neighboring beacon coverage to facilitate synergistic cross-selling. Several beacons may be needed in each section to identify local groups of products.
“Store Level Beacon”: Covers the entire store for Store identification.
“Produce Beacon”: Covers the Produce area.
“Bakery & Deli Level Beacon”: Covers the Bakery & Deli area.
“Meat & Seafood Beacons”: Covers the Meat & Seafood area.
“Dairy Beacon”: Covers the Dairy area.
“Pharmacy Beacon”: Covers the Pharmacy area.
“Liquor Area Beacon”: Covers the Wine & Liquor sections.
“Bank Beacon”: Covers the Bank/ATM area.
“Coffee Shop Beacon”: Covers the in-store Coffee Shop and the surrounding seating areas.
“Checkout Lane Beacons”: Cover each of the checkout lanes and the overlapping end-cap areas.
“Aisle Level Beacons” (shown as A-X and 1-8): Several beacons in each aisle are installed that cover groupings or categories of products both on the left and right sides of each aisle.

FIG. 13: Adding items to Universal Shopping Cart (USC) at different Retailers and Stores

FIG. 14: Browsing the USC

FIG. 15: Retailer specific shopping carts in the USC

FIG. 16: Contents of a Retailer specific shopping cart in the USC

FIG. 17: Drilling down to item level detail in a Retailer specific shopping cart in the USC

FIG. 18: Confirmation of an order placed using a Retailer specific shopping cart in the USC

FIG. 19: Browsing Orders in USC within an App

FIG. 20: List of orders placed from USC within a specified period

FIG. 21: Data-flow between various entities during transaction of an Order from a Shopper to a Merchant

FIG. 22: Retailer Pushes MBoxFile to MBoxServer

FIG. 23: Database of Retailers on MBoxServer associating collections of MBoxOffer and URL_Registry objects with each Retailer

FIG. 24: Anatomy of an MBoxOffer in an MBoxFile

FIG. 25: Anatomy of a URL_Registry Object

FIG. 26: Database of MBoxIDs and their associated client DeviceIDs on MBoxServer

FIG. 27: Anatomy of an MBox

FIG. 28: Client Device pulls Location and Personalization based MBoxOffers and URLs from MBoxServer

FIG. 29: Mapping of DeviceID to a unique MBoxID_M on MBoxServer

### DETAILED DESCRIPTION OF THE INVENTION

The current invention prescribes that a single app, referred to herein as the Universal Retail App (URA), should have all the capabilities and features provided by any retailer-specific app.

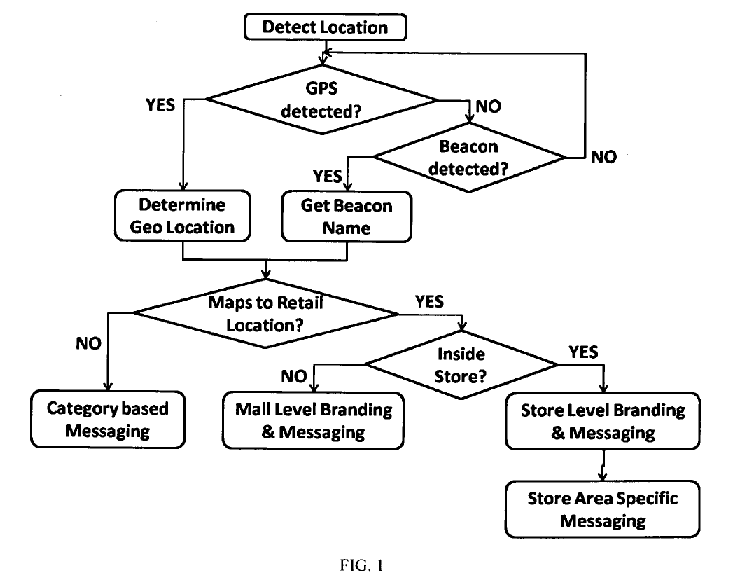

When the URA running in the background or foreground on a Smartphone detects a new location, it determines if it is far away from retail centers, near a retail center such as a mall or strip-mall, inside a mall or inside a store; the URA then sets its behavior and messaging accordingly. The URA detects its location either by GPS or by any of the methods described further in this patent. The location based determination of behavior and messaging by the URA is shown in FIG. 1.

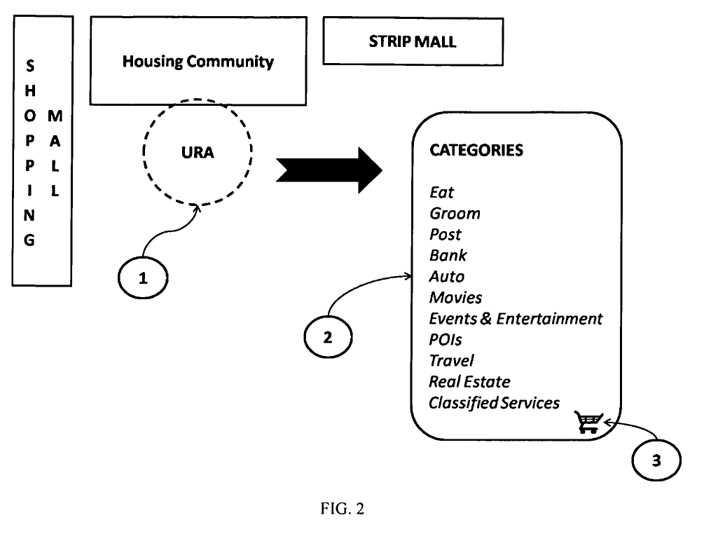

When the URA is activated at a location not near a retail center, the URA presents the following services: Locally available deals; brick-and-mortar businesses provided services and reviews/rankings categorized by service type such as eat, groom, bank, post, etc; classified services organized by categories such as handymen, child services, personal classifieds, etc; Events and Entertainment; Local Points of Interest; Movies; Comparative Shopping; Travel; Auto Dealers; Real Estate. The shopper is provided the capability to select any particular retail location and “drill-down” for greater detail. This use case is illustrated in FIG. 2.

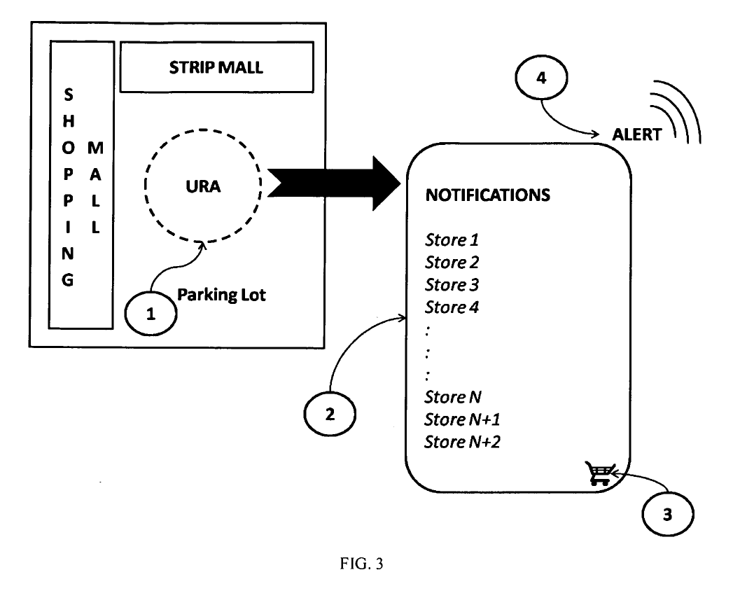

When the URA is activated in a shopping mall or a strip mall but not inside a store, the URA presents a view of the retail businesses within that mall with the option of widening the radius of coverage to include businesses outside the mall. Again, the shopper is provided the capability to select any particular retail business and “drill-down” for greater detail. This use case is illustrated in FIG. 3.

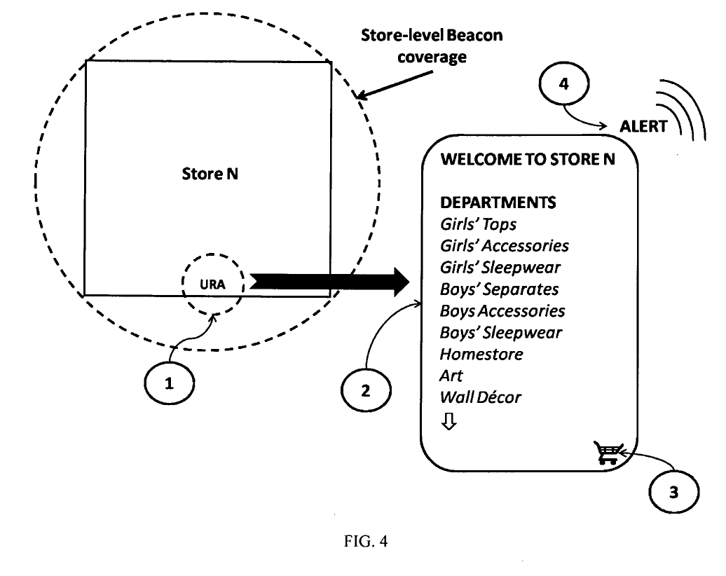

When a shopper initially enters a store, the URA presents the shopper with storewide special messaging, possibly personalized, that the particular retailer wants that shopper to see at the macro store level. This use case is illustrated in FIG. 4.

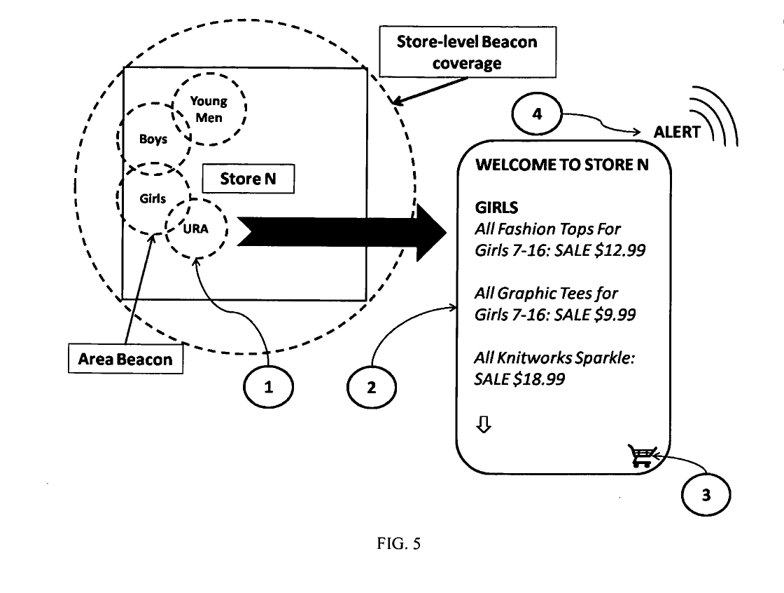

As the shopper walks around in different areas or regions of the store, the URA detects the particular region and presents to the shopper region-specific messaging. This use case is illustrated in FIG. 5.

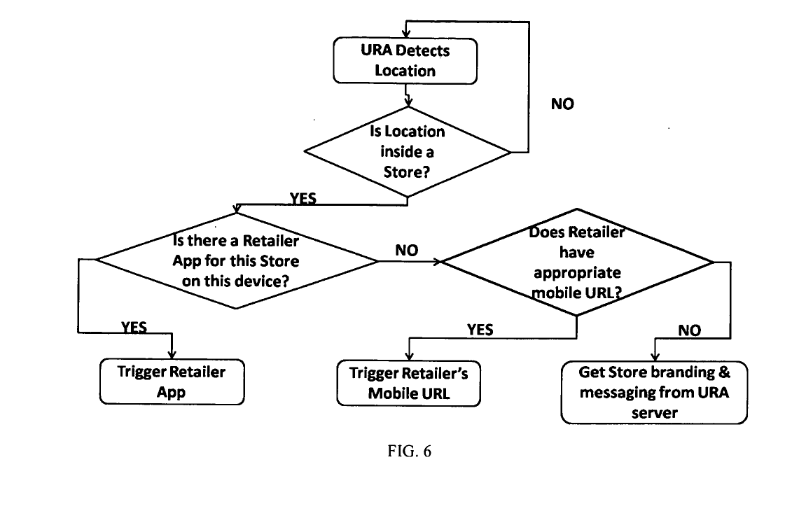

As shown in FIG. 6, the URA can handle the above scenarios in multiple ways including the following: (1) via integration with retailer and piping of retailer specific data and possibly further branding through URA servers in the cloud, (2) via triggering retailer-specific native app that may already be pre-loaded on the shopper's Smartphone, (3) connecting to a retailer provided dynamically or statically created URL for mobile devices that shows data that changes dynamically with URA location as well as personalized for each shopper.

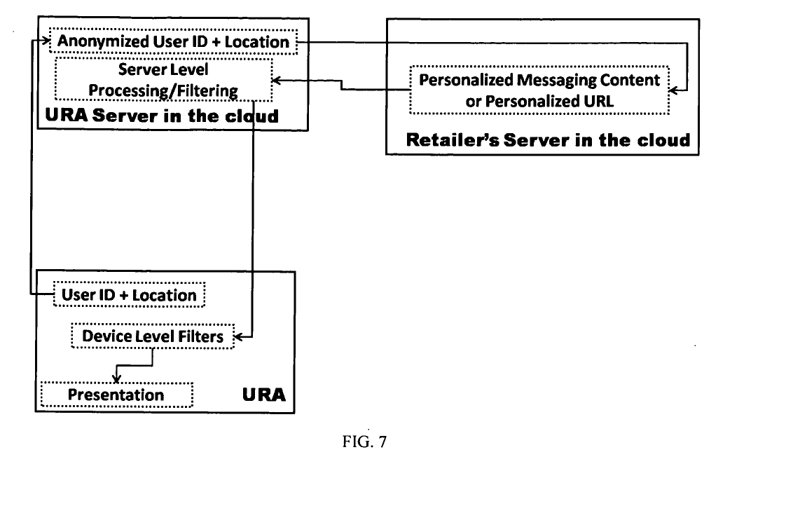

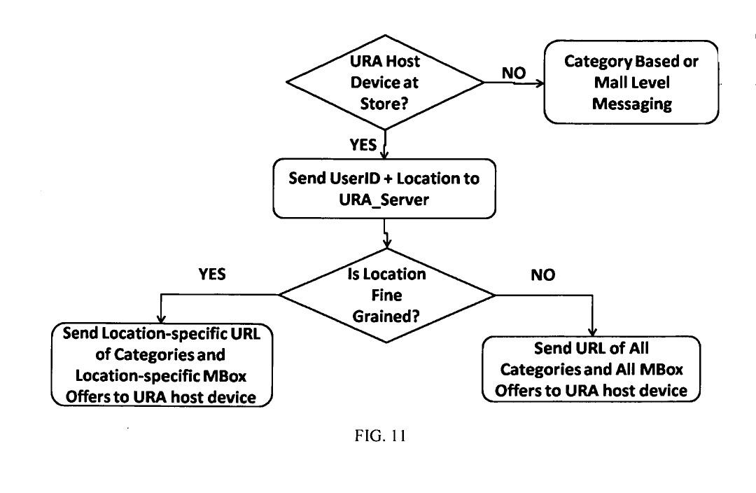

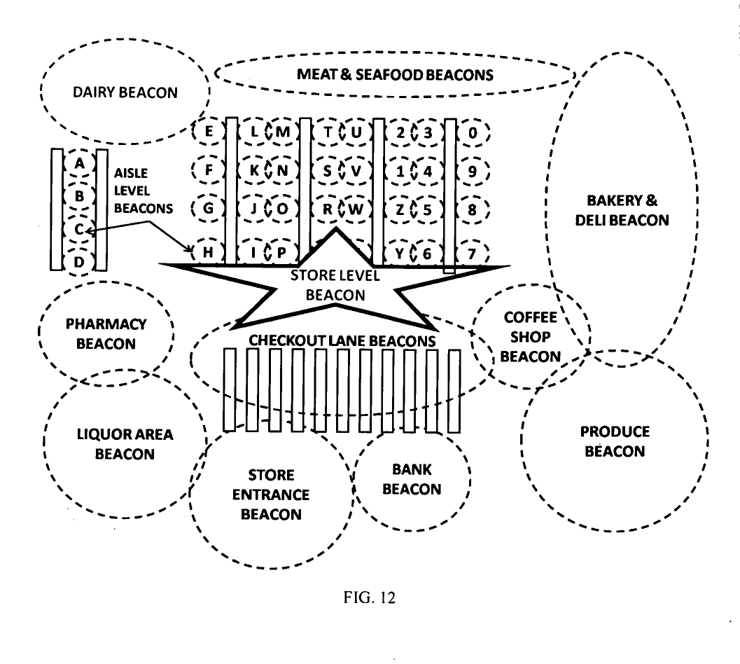

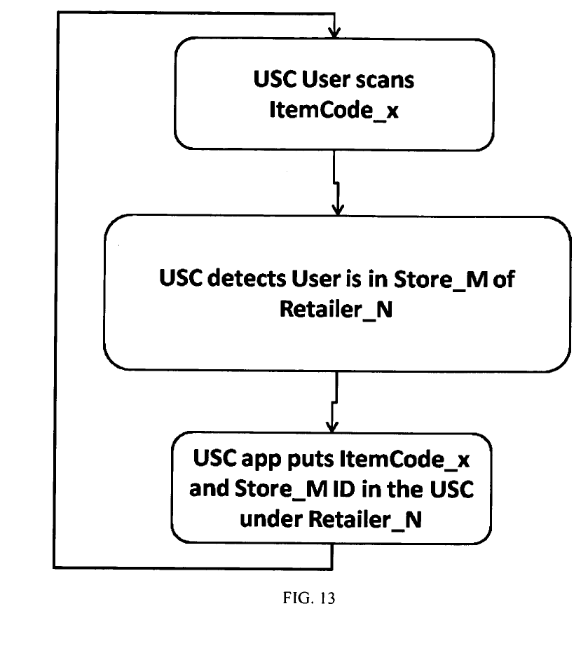

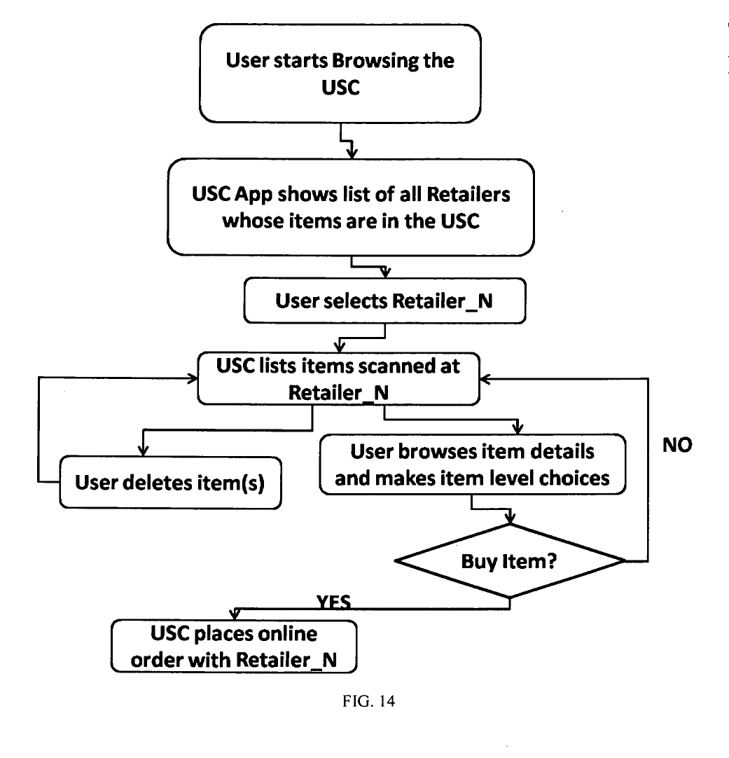

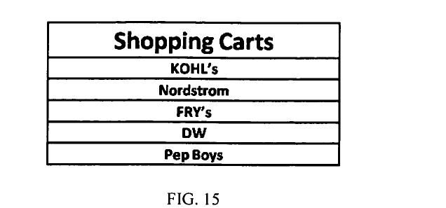

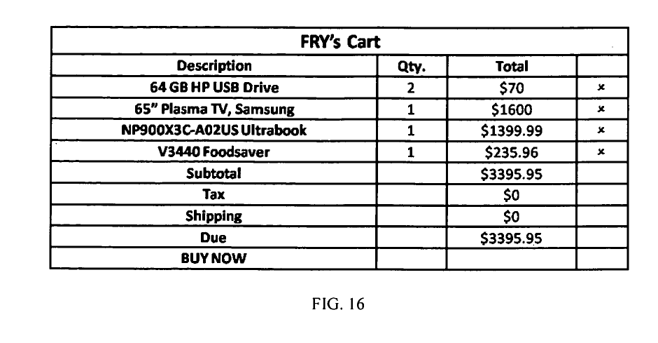

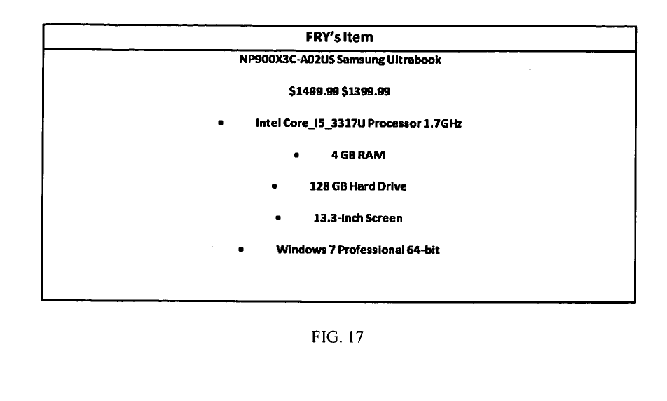

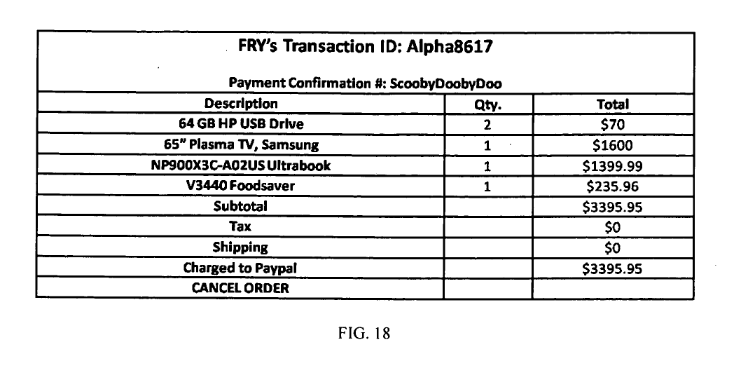

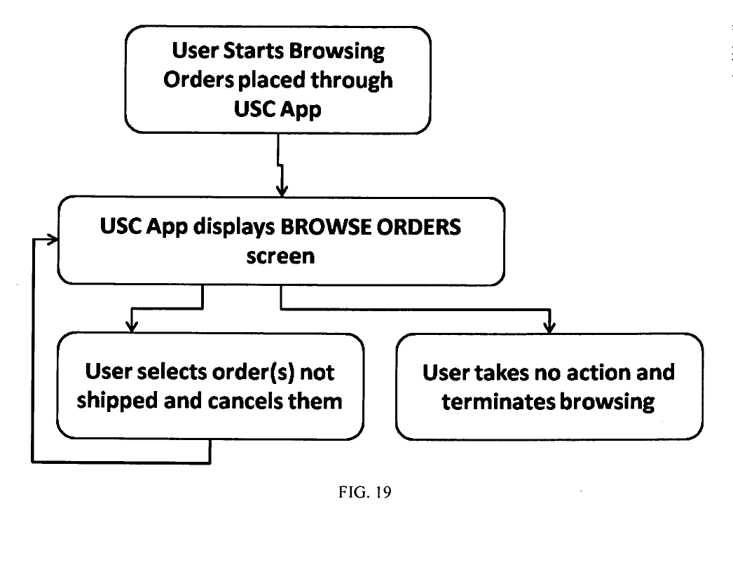

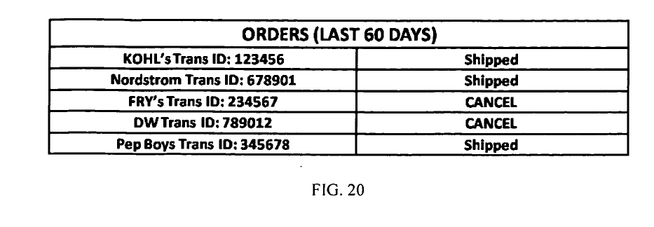

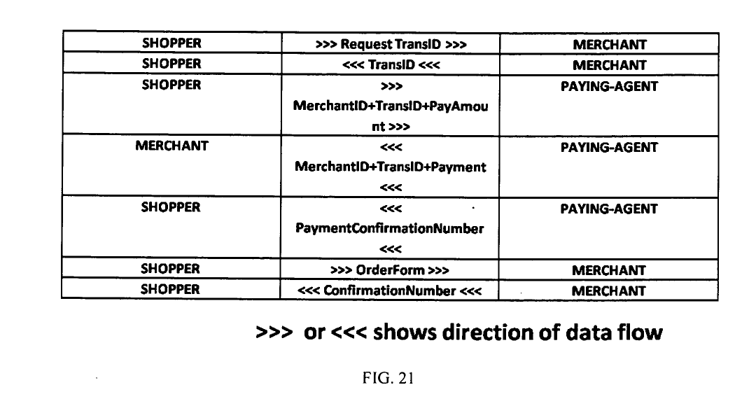

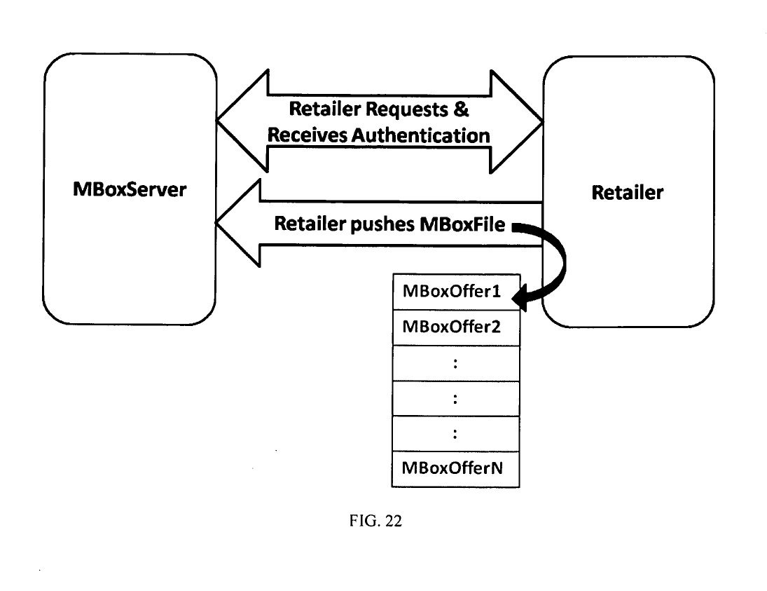

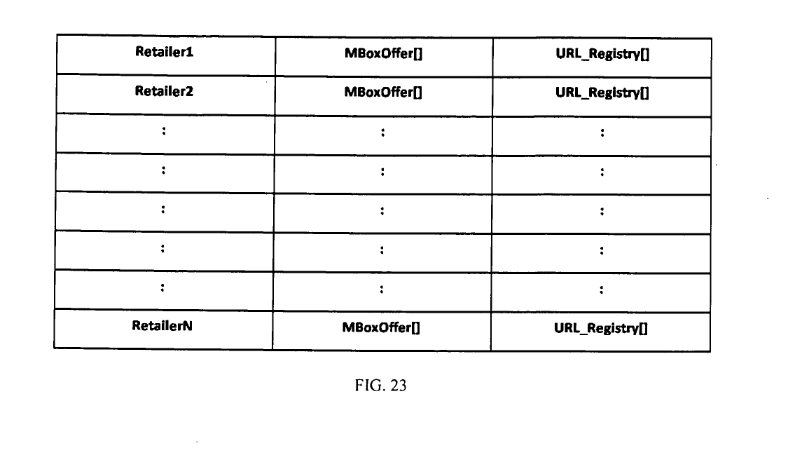

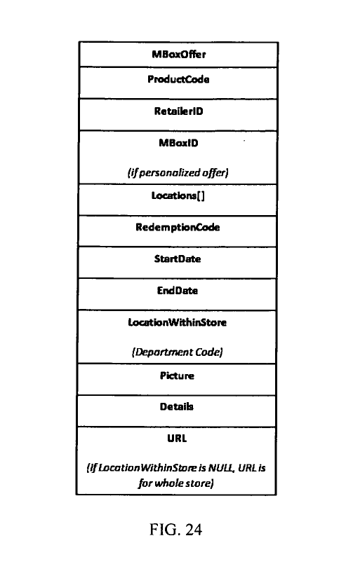

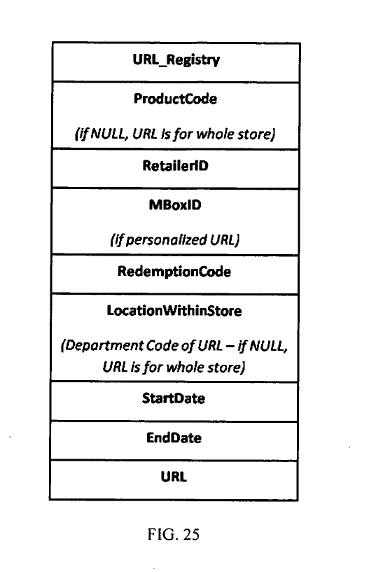

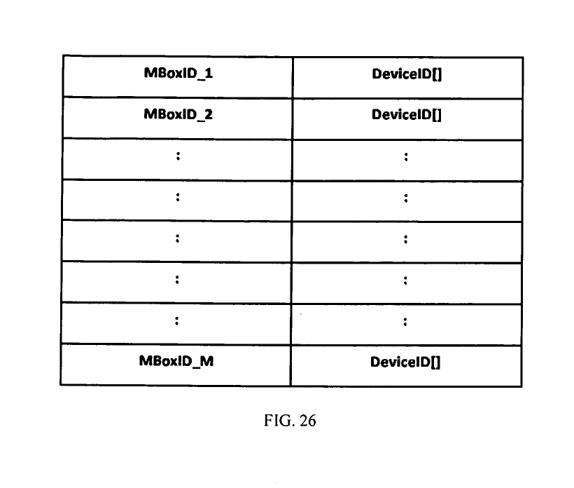

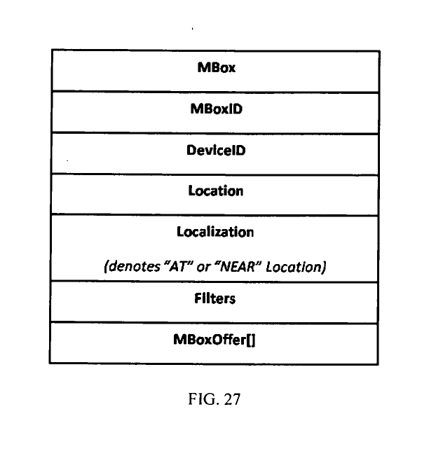

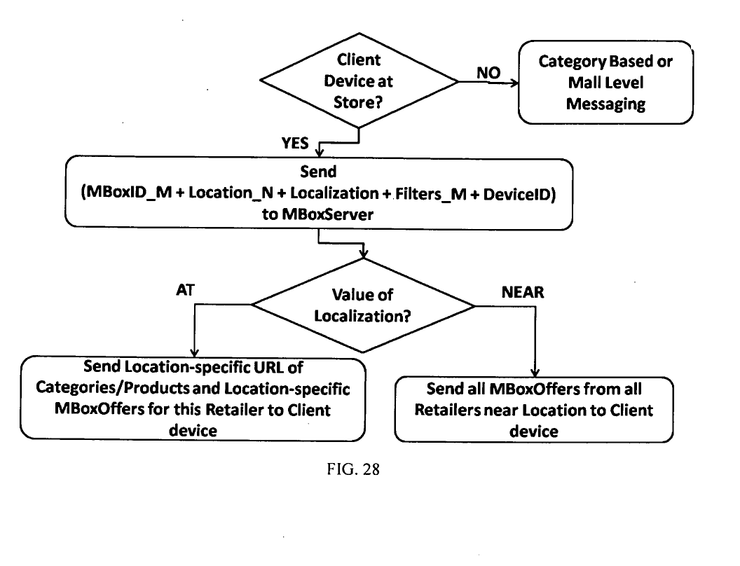

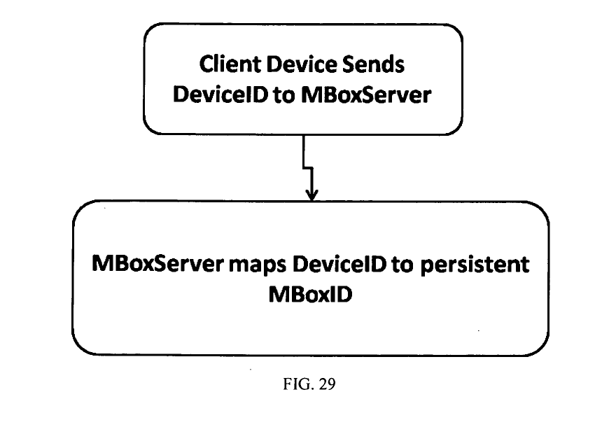

At every level, whether far from a retail center, at a retail center or inside a store/specific-store-region, the URA personalizes messaging to shopper via shopping history, shopper-specified rules and filters or retailer specified rules and filters as shown in FIG. 7. The URA Host Device passes the UserID, which is likely to be the SmartphoneID of the User, and Location to the URA_Server, which then passes both to the Retailer's Server after anonymizing the UserID. If the Retailer's Server is able to provide a dynamically created mobile URL tailored for location as well as personalized for each shopper, the URA is also able to connect to the mobile URL in real time and show personalized location-specific messaging. Also, as shown in FIG. 11, the URA can show the personalized and localized offers and URLs from the user's MBox on the URA_Server. The MBox is described later in this patent.

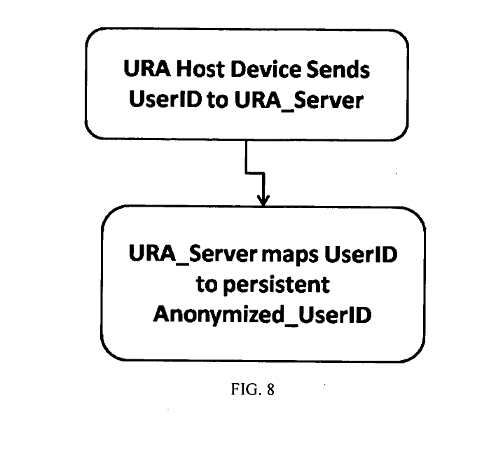

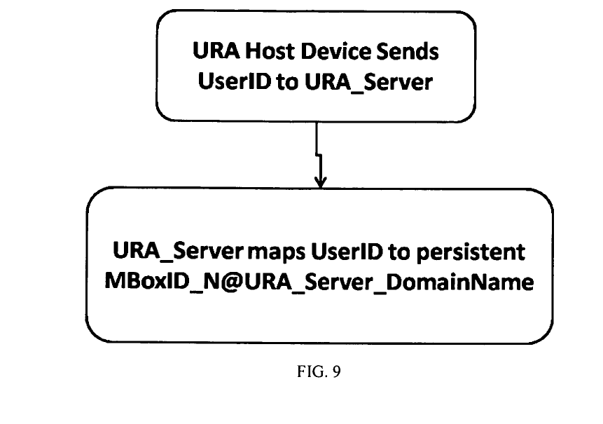

FIG. 8 shows an additional very useful feature of the URA. The URA Host Device (the Smartphone) passes the UserID of the URA Host Device owner (User) to the URA_Server to obtain messaging within the context of current Location and personalized to the User. The UserID is likely to be the SmartphoneID (the mobile phone number of the User) and the User likely wants it “anonymized” such that it maps to an Anonymized_UserID that can be shared with all Retailers without the Retailers having access to the User's SmartphoneID. As shown in this figure, the URA_Server provides this mapping. In addition, or alternately, the URA_Server can also allocate a Mailbox (MBox) with an associated ID (MBoxID) to each User where retailers can email Timed and Personalized Offers to each User. It would be the task of URA_Server to publish MBoxIDs to Retailers. Thus an Anonymized_UserID could take the form MBoxID_N@URA_Server_DomainName. This alternate anonymization of UserID is shown in FIG. 9.

A Timed and Personalized Offer (TPOffer) that a Retailer_X will send to an MBoxID_N@URA_Server_DomainName can nominally take the form:

{Retailer_X, TPOffer_Y, Start_Time_and_Date, End_Time_and_Date}.

TPOffer_Y is a personalized offer for a particular User Y and can be a complex data structure that may include images and text information.

A Timed and Personalized URL for a Location within a store (TPLocationURL) that a Retailer_X will send to an MBoxID_N@URA_Server_DomainName can nominally take the form:

{Retailer_X, TPLocationURL_Y, Location,
Start_Time_and_Date, End_Time_and_Date}.

TPLocationURL_Y is a valid URL for a given Location and is personalized for a particular User Y and the contents of the page it points to describe a given area of a store and/or the offers in that area of the store.

URA_Server also implements an algorithm that will continually look at the list of TPOffers and TPLocationURLs and delete the ones whose End_Time_and_Date have expired.

The MBox feature implemented on the URA_Server provides the Retailers useful and reliable access to their customers as well as a useful service to the customers without them having to deal with what is now considered “spam” in regular email. The MBox also manages itself, always staying fresh. The described features of MBox make the owners willing to widely share their MBoxIDs with Retailers without any security, privacy or spam concerns.

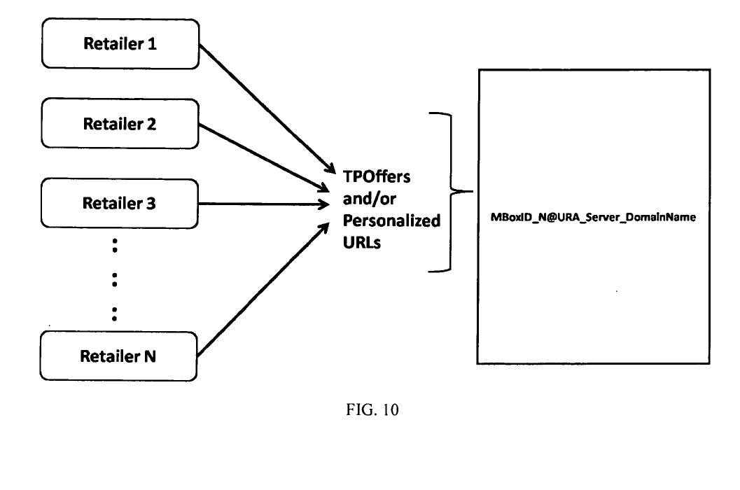

As shown in FIG. 10, any number of Retailers can push any number of TPOffers and TPLocationURLs to any number of MBoxes known to the Retailers. This push of data by Retailers to MBoxes can happen at any time and the data is made available to users of URA in real time. The MBox continuously monitors for stale messages and prunes them.

The preceding treatment of the MBox leaves the MBox on the URA_Server with only the URA pulling data from it behind the scenes without explicit involvement of the user. A feature can also be provided in the URA whereby users can actively browse, edit and configure their MBoxes stored on the URA_Server. The users could also set preferences as to the Retailers they want their MBoxID's published to.

URA uses the fine-grained locationing feature provided by Locationing of Mobile Devices using ISM Band Devices as Beacons to determine current location of the shopper and automatically triggers the app or various features within the app. For example, when the shopper is not near a retail center, the URA is quiescent unless manually triggered by the shopper as shown in FIG. 2. When the URA detects a change in location with shopper in the vicinity of, or at a mall, it automatically triggers mall-level messaging as shown in FIG. 3, without the shopper having to take specific actions. When the URA detects change in location within a mall such that a different store is in the vicinity or that the shopper has entered a store, it automatically triggers store-level messaging as shown in FIG. 4, without the shopper having to take any specific actions. When the URA detects that a shopper has moved to a different region of a store, it automatically triggers store-region specific messaging as shown in FIG. 5, without the shopper having to take any specific actions. Because of these critical features, the URA works silently and automatically in the background, piping messaging to the shopper. The messaging happens within the URA and is transient such that it expires and is replaced by new messaging as the shopper changes location. The shopper may set preferences parameters such that new messaging does not wake up the display and/or cause an audible alert, or the shopper may set the preferences parameters such that new messaging causes alerts such as waking up of the display, vibration and/or audible alerts. The shopper also sets an “Interested in” list that acts as a URA level filter to thin down the messaging he/she receives as shown in FIG. 7. Each retailer may also have their own personalization filters for each shopper, also as shown in FIG. 7.

An extremely useful feature of the URA by virtue of its fine-grained locationing capabilities due to Locationing of Mobile Devices using ISM Band Devices as Beacons, is the ability of the URA to automatically “sign-in” shoppers as soon as they enter a specific store. The “sign-in” feature is shown in FIG. 7 whereby UserIDs and Locations are transmitted to the URA_Server as soon as URA users enter stores. This allows applications running on the retailers' servers in the cloud to tailor the messaging specifically to each shopper in real-time and while they are in the store, shopping.

In addition to using the fine-grained and coarse-grained locationing provided by Locationing of Mobile Devices using ISM Band Devices as Beacons, URA also prescribes URA Host Devices' interaction with Near Field Communication (NFC) tags imbedded at locations or products within a store for additional fine-grained Location determination.

Shoppers using the URA may heed some or all of its messaging and may make purchase decisions based on the messaging while they are in the store, or the messaging may pique their interest enough in certain merchandize that they want to “make a note” of it, possibly with an intention of purchasing it later. The URA makes this possible by imbedding in it features of a Universal Shopping Cart referred to hereafter as the USC. The USC allows shoppers to scan products from any retailer and save them within a shopping cart database maintained within the URA for later browsing, research and online purchase decisions. The URA using the USC allows triggering of retailer specific purchases seamlessly without separate sign-ons and authentications for each of the retailers referenced in the USC. The USC will be described here in detail further in this patent.

The current invention prescribes methods for using commonly deployed ISM Transceivers (referred to hereafter as ISM-Beacons) to transmit information to Smartphone Client-Devices from which location information can be extracted.

The location information extracted may or may not need to be the ISM-Beacon's absolute location depending on how the Smartphone Client-Device intends to use the information. The location information transmitted by the ISM-Beacons can be Geo-Coordinates or any other meaningful string that the Smartphone Client-Devices can parse into location meaningful to the applications running on the Client-Devices. Following are just two examples of locations that ISM-Beacons could be programmed to transmit:

1. Geo-Coordinates transmitted as degrees/minutes/seconds: 40:26:46N 79:56:55W. Other formats for Geo-Coordinates may also be used.

2. Location transmitted as any other string meaningful to the applications running on the Client-Devices, for example: “Mom&PopStore #173, BigBoxStore #2737”, or the MAC ID of the ISM-Beacon, etc.

The ISM-Beacons can be those commonly used as access points or gateways for Wireless LAN or PAN, or they may be based on proprietary protocols supported by the Client-Devices. Commonly deployed ISM-Devices are Bluetooth (2450 MHz band), HIPERLAN (5800 MHz band), WiFi (2450 MHz and 5800 MHz bands) and Zigbee (915 MHz and 2450 MHz bands). Use of ISM-Devices using other protocols and/or bands is also included in the current invention, examples of which are NFC and RFID tags.

The current invention prescribes the discovery of nearby ISM-Beacons without the need for any hardware modification to the Client-Devices. This means that the discovery process must be based on a standard RF network discovery handshake process that the Client-Devices must be aware of a-priori. The current invention prescribes the use of ISM-Beacon ID or Name to be, or contain the location information, in any chosen format; two such formats for Geo-Coordinates and named Location strings are described above. Thus, when a Client-Device discovers an ISM-Beacon, it uses the ID or Name of the ISM-Beacon to extract the location information.

As an example, a WiFi Access Point can be set up as an ISM-Beacon where its SSID name space can be used entirely to signify the location information. An SSID is a name that identifies a particular 802.11x wireless LAN. A Client-Device receives broadcast messages from all access points within range broadcasting their SSIDs. The SSID is defined to be 32 characters long, each of which may take any value. Following is an example of how in one implementation, the SSID name space can be segmented to provide unique location identification for the ISM-Beacon to transmit to the Client-Devices:

1. StoreName: 6 octets

2. StoreID: 4 octets

3. LocationWithinStore: 2 octets

4. Geo Coordinatess: 20 octets (written as DegreesMinutesSeconds with no spaces: dd:mm:ssNddd:mm:ssW)

Similarly, Bluetooth master or Zigbee access points could be configured as ISM-Beacons and their device name space segmented in a manner similar to or same as the example given for WiFi access points.

The current invention also prescribes that the range of the ISM-Beacons can be configured to be suitably large or small to provide the possibility of several ISM-Beacons to coexist in an enclosed space and uniquely identify their regions of coverage. Several beacons may be needed in each section to identify local groups of products. If a Client Device enters a region with overlapping ISM-Beacon ranges, it may disambiguate its location based on Received Signal Strength (RSS) of the signal received from the ISM-Beacons—or it may decide that it is within the range of all the overlapping ISM-Beacons. See FIG. 12. Overlapping coverage of neighboring beacons can be used to facilitate synergistic cross-selling.

The ISM-Beacons can be configured to not transmit any other data to and from the Client Devices besides the location information encoded in the ISM-Beacon namespace. Then the ISM-Beacons can be built as functionality stripped down devices not requiring to be connected to a LAN and can be devices that can stay alive on battery power for a few years.

Another feature referred to earlier as a Universal Shopping Cart (USC), can be imbedded in the URA or in any shopping enabled websites or mobile apps or as a standalone mobile app, that shoppers can add items to while shopping/browsing in a real physical store or an online store, browse and edit the USC and buy any of the items in the USC from any Retailer with only a one time initial sign-on for payment-processing authentication on the USC. The users of the USC would have previously registered their payment method with the USC and that payment method is automatically triggered when purchase(s) are made through the USC. The USC completes all transactions seamlessly behind the scenes without the shoppers having to interact individually with each of the retailers. The USC also handles payment processing through integration with Payment Processing companies.

The USC is immensely useful to the shoppers as they may not be able to make buying decisions for a variety of reasons while they are actually at the point of purchase. With the USC, shoppers can store the items they wish to buy, have access to the cart at any retailer, and make the buying decision at their convenience.

Use of the USC by shoppers is immensely beneficial to the Retailers as well since the number of “lost sales” due to shopper-indecision will go down as the shoppers can buy the items in their USC at any time even after they have left the stores. Another benefit to the Retailers is that the USC content for a particular Retailer along with the Shopper's ID in some form can be shared with the Retailer giving the retailer a chance to send incentives to the shopper to make the sale. This kind of USC content and ShopperID sharing with the Retailer along with the Retailer's transmission of incentives to the Shopper is best done via the MBox feature described further in this patent.

FIG. 13 shows the case when a shopper has started the USC App and scanned an item with a code ItemCode_x. The USC automatically detects that the shopper is in Store_M of Retailer_N and puts both ItemCode_x and Store_M_ID into the USC under Retailer_N. The shopper may repeatedly continue this activity for various items within the same store or across multiple stores belonging to various Retailers.

FIG. 14 shows the case where the shopper starts browsing the contents of the USC. As shown in FIG. 15, the USC App shows the list of all the Retailers whose items are currently in the USC. The shopper then selects a particular Retailer and as shown in FIG. 16, the USC App then shows the list of items in the USC for that particular Retailer. As shown in FIG. 17, the Shopper may then select any of the items in the USC and is then shown details about the item such as UPC, Image and Price and allows selection of details such as Color and Size, if applicable. The Shopper may then select BUY on screen in FIG. 16, order is placed and a confirmation screen appears as in FIG. 18.

FIG. 19 shows the browsing of Orders placed by a shopper from her USC. When BROWSE ORDERS is triggered in the USC App, a screen such as FIG. 20 appears that shows the list of Orders placed from the USC within a specified period and the orders that have been shipped and ones that can still be cancelled. Picking of any of these orders shows up a screen similar to as shown in FIG. 18—allowing cancelling of the order if it has not been shipped; if the order has already been shipped, screen such as in FIG. 18 does not have CANCEL enabled.

FIG. 21 shows the kinds of data that flows in the background between various entities during the ordering process. When the Shopper places an Order, the USC App requests a transaction ID, TransID, from the Merchant. The USC App then transmits the TransID, MerchantID and the PayAmount to the Paying-Agent that processes the payment directly to the Merchant referring to the TransID and MerchantID, and returns a PaymentConfirmationNumber to the USC App. The USC App then transmits the complete OrderForm including the list of items bought and PaymentConfirmationNumber to the Merchant and receives back a ConfirmationNumber. This completes the Ordering transaction. The Merchant then ships orders directly to the shopper along with merchandize return information.

Finally we describe the MBox feature of the present invention which is a system for marketing by Retailers to Consumers that is cost-effective, real-time, one-to-one and available to Consumers, metered by context and location, and can be made available at or near the Point-of-Purchase such that the Consumers are not turned off by burdensome out-of-context promotional messaging. This communication system can be used by Retailers to communicate with Consumers using either desktop computing platforms or mobile communication and computing platforms. The system described keeps promotional messaging out of Consumers' business and personal messaging channels and is self-managing such that stale and out-of-context messaging never accumulates and the Consumers never have to manage the messages explicitly.

FIG. 22 shows a major component of the MBox—the MBoxServer which is an application hosted in the cloud. The MBoxServer allows participating Retailers to authenticate themselves and upload files, referred to herein as MBoxFiles, containing promotional deals and offers that are annotated for regions and time periods of validity, may be personalized, and can be offered to any Consumer anywhere.

The Retailers can also upload to the MBoxServer, other types of structured information such as promotional URLs customized by location, time period and personalization. FIG. 23 shows an example of a database table that the MBoxServer would maintain which allows it to lookup various types of offers that a Retailer has to offer via MBoxOffer and URL_Registry objects.

FIG. 24 shows the anatomy of a promotional offer, MBoxOffer, that an MBoxFile is a collection of. Using common programming notation for the fields inside MBoxOffer, MBoxOffer.ProductCode is a handle, such as a UPC, for the product being offered. MBoxOffer.RetailerID is a field that uniquely identifies the Retailer offering the deal. MBoxOffer.MBoxID is a field that uniquely identifies a particular Consumer if this offer has been personalized for this consumer; if this offer is not personalized, the MBoxOffer.MBoxID field is NULL. MBoxOffer.Locations[ ] uniquely specifies the locations of the stores that the deal is available at. If this field is NULL, the deal is available at all stores of the Retailer. MBoxOffer.RedemptionCode is a unique identifier for this particular offer. MBoxOffer.StartDate and MBoxOffer.EndDate specify the start and end dates between which this offer is valid. Here it is assumed that the offer is valid from 00:00 on StartDate to 24:00 on EndDate. Additional fields such as StartTime and EndTime may also be specified. MBoxOffer.LocationWithinStore is a field that identifies the Department in which this item being offered is to be found. MBoxOffer.Picture is a picture of the merchandize being offered. MBoxOffer.Details is a text field that describes the offer in greater detail such as: product name, description, price, etc. The MBoxOffer.Details field can also be an annotated or structured field to contain named fields. Other named fields such as item or product specific URL may also be included in MBoxOffer as shown in FIG. 24. If MBoxOffer.LocationWithinStore field is NULL, MBoxOffer.URL can pertain to a URL for the entire store; else it can refer just a product or an entire Department within the store.

FIG. 25 shows the anatomy of a URL_Registry object, a collection of which can also be transmitted by Retailers to MBoxServer. Using common programming notation for the fields inside URL_Registry, MBoxOffer.ProductCode is a handle, such as a UPC, for the product being offered. URL_Registry.RetailerID is a field that uniquely identifies the Retailer to whom the URL belongs. URL_Registry.MBoxID is a field that uniquely identifies a particular Consumer if this URL has been personalized for this consumer; if this URL is not personalized the URL_Registry.MBoxID field is NULL. URL_Registry.RedemptionCode is a unique identifier for this particular offer. URL_Registry.LocationWithinStore is a field that identifies the Department if this URL is for a particular Department within the store—if NULL, the URL is for the entire store, else it refers to a particular product or a particular Department within the store. URL is the actual URL. The data object shown in FIG. 25 is almost identical to that in FIG. 24 but is called out as a separate object since it is likely that the Retailers' servers may actually be called upon by Customer applications to custom make and serve this object in real-time, while the object in FIG. 24 can be “pre-made” and registered with the MBoxServer.

FIG. 26 shows that MBoxServer has access to a database of MBoxID fields where each MBoxID is assigned to a unique Consumer and is also associated with mobile and/or desktop DeviceID(s) that the Consumer owns and wants associated with this MBoxID.

As shown in FIG. 27, MBoxServer creates an MBox for each MBoxID in real-time every time MBoxServer receives a request from a Client Device that passes the set {MBoxID, DeviceID, Location, Localization, Filters} up to MBoxServer. MBoxServer stores this set of information in the MBox object. The MBoxServer then uses the MBox.Location field to create a temporary collection of all Retailers at that location, RetailersAtLocation[ ]. If the MBox.Localization field specifies “AT,” then RetailersAtLocation[ ] is just one Retailer. If the MBox.Localization field specifies “NEAR,” then RetailersAtLocation[ ] contains all the Retailers near that Location. The MBoxServer then loops over each Retailer in RetailersAtLocation[ ] and fills up MBox.MBoxOffer[ ] with offers from each Retailer's MBoxFile, filtering out categories not specified in MBox.Filters. If a given Retailer has provided personalized offers for the MBoxID currently being serviced, then the personalized offers are stuffed in MBox.MBoxOffer[ ] before stuffing the general offers.

FIG. 28 shows a client device that has MBoxID_M associated with it and is at Location_N, making a request to MBoxServer to send back MBoxOffers from all Retailers pertaining to Location_N. The client device also includes Filters_M which are personalized filters for MBoxID_M that the client device requires to be applied in addition to Location_N, when selecting MBoxOffers from all the MBoxFiles for all the Retailers. The client device also specifies Localization to determine if MBoxOffers must be returned for the retailer AT the exact Location_N, or for all the Retailers NEAR the vicinity of Location_N. The object Location can be as fine grained as a store Department level, or a store level, or can be an exact GPS coordinate.

The MBoxServer keeps track of the frequency of visits and of lengths of time an owner of an MBoxID spends at each Retailer and can share this statistics with Retailers. The Retailers can then analyze this statistics to determine favored customers and send offers personalized for each favored customer MBoxID. These offers are different from those given to everyone in the MBoxFiles. As shown in FIG. 24, these personalized offers are annotated in the object MBoxOffer by virtue of MBoxID field not being NULL.

FIG. 29 shows mapping or anonymization of a DeviceID of the client device such as a Smartphone to a universally publishable MBoxID. The application running Client Device (the Smartphone) passes the DeviceID of the Client Device to the MBoxServer to obtain messaging within the context of current Location and personalized to the User. The DeviceID is likely to be the SmartphoneID (the mobile phone number of the User) and the User likely wants it “anonymized” such that it maps to an MBoxID that can be shared with all Retailers without the Retailers having access to the User's SmartphoneID. As shown in this figure, the MBoxServer provides this mapping. Retailers can send Timed and Personalized Offers to the MBoxServer for each User annotated with the MBoxID. It would be the task of MBoxServer to publish MBoxIDs to Retailers.

MBoxServer also implements algorithms that continually look at the list of MBoxOffers and URL_Registry objects and delete the ones whose EndDate have expired.

The MBox feature implemented on the MBoxServer provides the Retailers useful and reliable access to their customers as well as a useful service to the customers without them having to deal with what is now considered “spam” in regular email. The MBox also manages itself, always staying fresh. The described features of MBox make the owners willing to widely share their MBoxIDs with Retailers without any security, privacy or spam concerns.

It is evident from the preceding description of MBox that MBoxOffers are generated in real-time only when an application on Client Devices pulls data from the MBoxServer triggered automatically by a change in Location of the Client Device or by explicit trigger from the user. The application on the Client Device can also enable users to actively browse their MBoxOffers and edit their Filters used by MBoxServer to build their MBoxOffers. The users can also set preferences on MBoxServer as to the Retailers they want their MBoxIDs published to.

I claim:

1. A Universal Retail App (URA) for Smartphones and other mobile communication devices that auto-detects its location and launches itself in the context of its location and its user set preferences, and if in a retail location, mimics or runs that retailer's native app or takes on the retailer's native branding and provides the retailer-specific information, services, product offerings and other messaging personalized to the user, dictated in real time by the retailer's web based marketing infrastructure.

2. Accurate Locationing schemes comprising of:
the use of ISM Band Devices as beacons, whether working in their normal mode of operation or specifically configured for beaconing and range limitation;
methods for coding Geo-coordinates or named location within the ISM Device ID or Name fields in any chosen format;
methods for extraction of location information by interpreting ISM Device ID or Name or other information transmitted by the beacons;
the use of Received Signal Strength (RSS) for disambiguation of overlapping beacon signals.

3. The URA of claim 1 wherein the locationing schemes include the schemes specified in claim 2.

4. Method for Retailers, MBox, to send personalized messaging to individual shopper's Smartphone or other mobile communications device, comprising of:
anonymizing shopper's Smartphone ID by converting it into a MBoxID handle that uniquely identifies the shopper and sharing the handle with all retailers;
publishing messaging formats and messaging attributes to Retailers that Retailers can use to send annotated and automatically parsable electronic messages targeted to each MBoxID that it knows about;
making available an MBoxServer application on the Web to receive messages destined for various MBoxIDs and that sorts and routes the messages in real-time to individual MBoxID owners based on their location and discards messages that have expired or become stale.

5. The MBox of claim 4 wherein the locationing schemes include the schemes specified in claim 2.

6. The URA of claim 3 wherein the MBox of claim 5 features are imbedded and MBox is an included method of Retailer to Shopper direct messaging in the URA.

7. A virtual Universal Shopping Cart, USC, for Smartphones and other computing and communication devices, that can be imbedded in apps and browsers, or be a standalone application, and can be used to conduct eCommerce in a Retailer agnostic fashion either inside a physical store location or virtually online and comprising of:
feature to scan in merchandize to add it to a shopping list;
ability to determine location and infer if the USC user is in a particular retail store;
all the features necessary to conduct eCommerce with any Retailer whose merchandize has been added to the shopping list within the USC;
ability to receive messaging directly from retailers for items that may or may not be in the shopping list.

8. The USC of claim 7 wherein the Retailer to USC user messaging method includes the MBox of claim 5.

9. The URA of claim 6 wherein the USC of claim 8 is imbedded as a feature.
